(19) United States
(12) Patent Application Publication
(10) Pub. No.: US 2011/0165552 A1
(43) Pub. Date: Jul. 7, 2011

(54) Reading menu folder (RMF) system - aka the reading menu folder

(76) Inventor: Carol E. Foster, Williamsburg, VA (US)

(21) Appl. No.: 12/655,710

(22) Filed: Jan. 6, 2010

(51) Int. Cl. G09B 3/00; G09B 7/00

(52) U.S. Cl. 434/430

(57) ABSTRACT

Exemplary embodiments of a reading menu folder system is provided. The reading menu folder system comprises a front cover, a back cover having a reading assignment log, and a plurality of folders. Each folder is associated with a literary genre or literary genre sub-category and configured to hold a book associated with the literary genre or literary genre sub-category. The reading menu folder system is arranged to be customized for a reader based on age, curriculum, interests.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

I. Field

The invention relates to a reading menu folder system for teaching literature and literacy and to encourage individuals to engage in reading literature.

II. Background

Currently large segments of children are deficient in reading and literacy. Many children in the United States have been determined to perform below grade level in reading. The deficiency may be in decoding or reading comprehension. Additionally, many children are not motivated in reading on a regular basis.

Children deficient in reading generally perform less successfully in academics. Some children drop out of high school because of their inability to competently read. Reading deficiencies also give rise to deficient analytical and critical thinking abilities.

Thus, there is a need for a reading menu folder system to teach literature and literacy through a reading menu folder system configured to organize and track reading of a plurality of literary works in a manner that is comfortable, entertaining and customizable to the reader.

Thus, there is a need for a reading menu folder system that can be used as a teaching tool to teach a plurality of genre, types of literary work, and/or series of literary work including poetry, cultural heritage, and great classics.

### SUMMARY

The aforementioned problems, and other problems, are reduced, according to exemplary embodiments, by the reading menu folder system and methods for organizing and tracking reading of a plurality of literary works are set forth below.

According to an exemplary embodiment, a reading menu folder (RMF) system is provided. The RMF system comprises a front cover, a back cover having a reading assignment log, and a plurality of folders, each folder being associated with a literary genre or literary genre sub-category and configured to hold a book associated with the literary genre or the literary genre sub-category.

According to another embodiment, the reading menu folder system is electronic. The electronic reading menu folder system comprises a memory for storing instructions; and processor for executing a set of the stored instructions to customize a reading menu folder system with literary works and reading assignments.

Other systems, methods, and/or products according to embodiments will be or become apparent to one with skill in the art upon review of the following drawings, and further description. It is intended that all such additional systems, methods, and/or products be included within this description, be within the scope of the present invention, and be protected by the accompanying claims.

### BRIEF DESCRIPTION OF THE DRAWINGS

The above and other exemplary embodiments, objects, uses, advantages, and novel features are more clearly understood by reference to the following description taken in connection with the accompanying figures wherein:

FIG. 1 illustrates a perspective view of reading menu folder (RMF) system in accordance with some exemplary embodiments of the present invention;

FIG. 2A illustrates a perspective view of a literature holding pocket folder in accordance with some exemplary embodiments of the present invention;

FIG. 2B illustrates a perspective view of yet another literature holding pocket folder in accordance with some exemplary embodiments of the present invention;

FIG. 3 illustrates a perspective view of a first (optional) literature holding pocket folder holding a first type of literature in accordance with some exemplary embodiments of the present invention;

FIG. 4 illustrates a front view of a literature holding pocket folder pair holding second and third types of literary works in accordance with some exemplary embodiments of the present invention;

FIG. 5 illustrates a perspective view of a second (optional) literature holding pocket folder holding a type of literary works in accordance with some exemplary embodiments of the present invention;

FIG. 6 illustrates a front view of front and back cover members of yet another RMF system in accordance with some exemplary embodiments of the present invention;

FIG. 7 illustrates an electronic RMF system in accordance with some exemplary embodiments of the present invention;

FIG. 8 illustrates a graphical user interface (GUI) for use by the electronic RMF system of FIG. 7 in accordance with some exemplary embodiments of the present invention;

FIG. 9 illustrates a graphical user interface (GUI) of FIG. 8 with drop down windows in accordance with some exemplary embodiments of the present invention;

FIG. 10 illustrates a graphical user interface (GUI) for customizing a reading menu folder in accordance with some exemplary embodiments of the present invention; and

FIG. 11 illustrates a flow chart to customize a reading menu folder to teach literature and/or literacy in accordance with some exemplary embodiments of the present invention;

FIG. 12 illustrates yet another perspective view of reading menu folder (RMF) system in accordance with some exemplary embodiments of the present invention; and

FIG. 13 illustrates yet another perspective view of reading menu folder (RMF) system in accordance with some exemplary embodiments of the present invention.

### DESCRIPTION

The word “exemplary” is used herein to mean “serving as an example, instance, or illustration.” Any configuration or design described herein as “exemplary” is not necessarily to be construed as preferred or advantageous over other configurations or designs. Furthermore, use of the words “present invention” is used herein to convey only some of the embodiments of the invention. For example, the word “present invention” would also include alternative embodiments and equivalent systems and components that one of ordinary skill in the art understands. An example is that the materials used for the exemplary embodiments may be made out of man-made materials, natural materials, and combinations thereof. A further example is that the apparatus or components of the apparatus may be manufactured by machine(s), human(s) and combinations thereof.

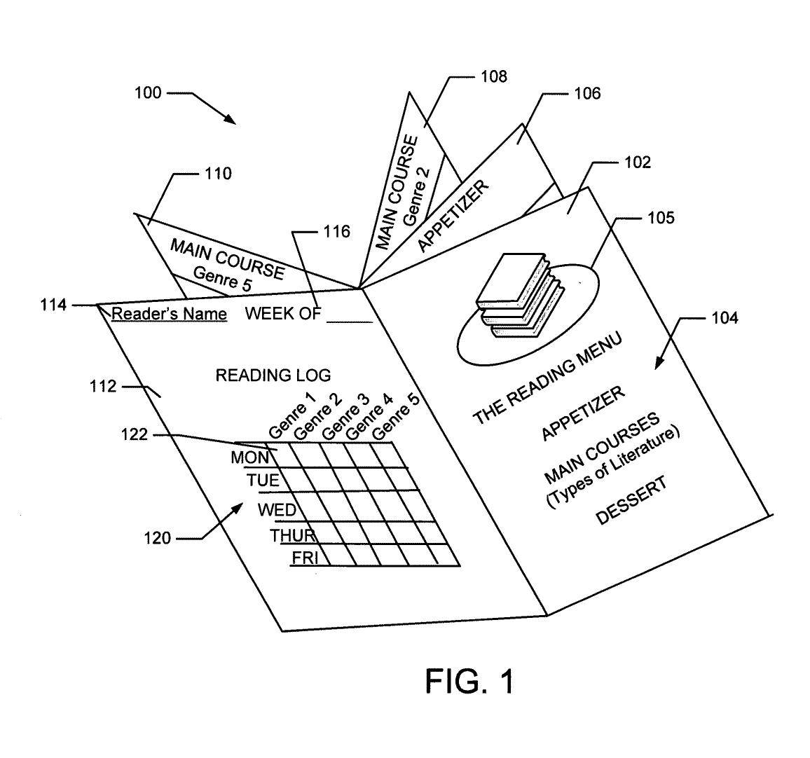

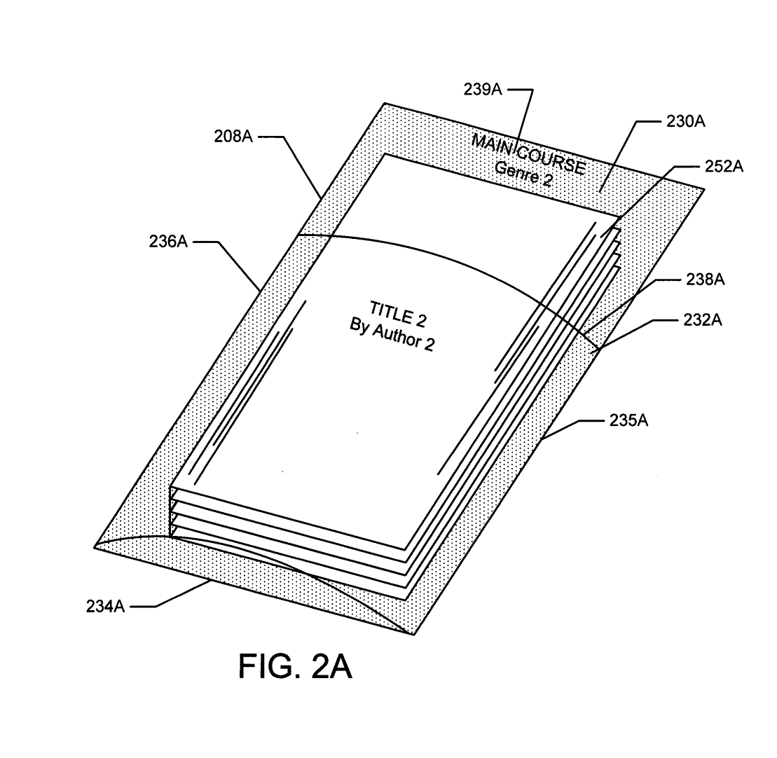

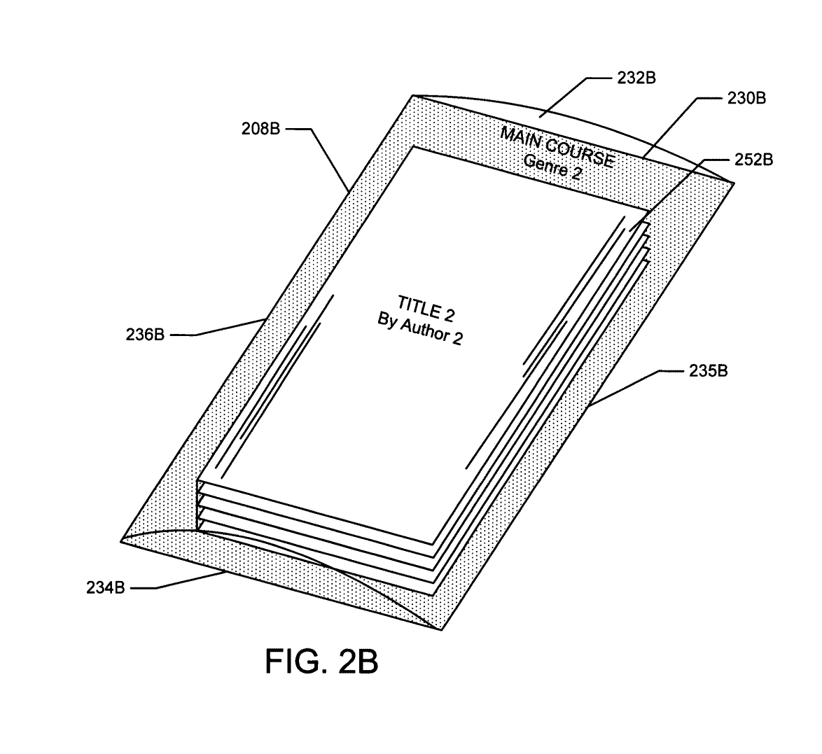

Within the descriptions of the figures, similar elements are provided similar names and reference numerals as those of the previous figure(s). Where a later figure utilizes the same element or a similar element in a different context or with different functionality, the element is provided a different leading numeral representative of the figure number (e.g., 1xx for FIGS. 1 and 2xx for FIG. 2). The specific numerals assigned to the elements are provided solely to aid in the description and not meant to imply any limitations (structural or functional) on the invention.

Some of the embodiments of the invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

The RMF system is configured to track and record manually or electronically completion of a plurality of reading assignments. The reading assignments may be daily, weekly, monthly, or other intervals. The RMF system includes a log to manually or electronically enter and track reading of a user.

The RMF system is configured to organize, store and hold a plurality of literary works. In an exemplary embodiment, the literary works are associated with a different literary genre. (Genre is a French word meaning type or kind).

The RMF system is configured to provide a plurality of pocket folders to hold and organize a plurality of literary works by genre for a particular reading level. A cover panel of the RMF system includes a reading entry log for use by the user.

The RMF system is configured to organize and track reading of a plurality of literary works in a manner that is comfortable, entertaining and customizable to the reader.

FIG. 1 illustrates a perspective view of reading menu folder (RMF) system 100 in accordance with some exemplary embodiments of the present invention. The RMF system 100 is folder assembly in the form of a booklet or binder with a front cover 102, a back cover 112 and a plurality of pocket folders (only 106, 108 and 110 shown) between the front cover 102 and the back cover 112. Each pocket folder is associated with a different literary genre or literacy work.

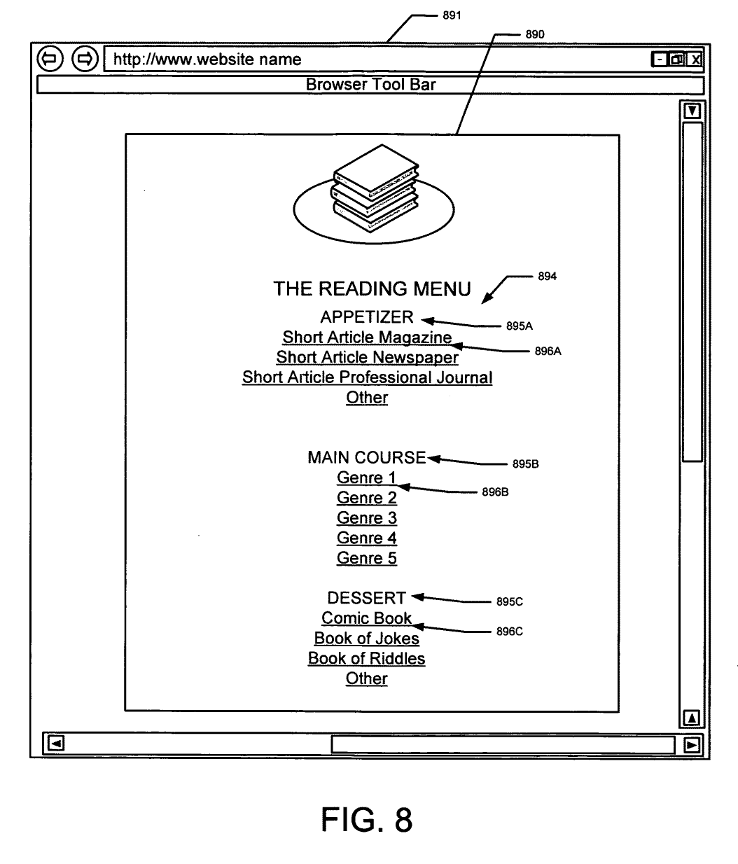

The front cover 102 of the folder assembly includes a reading menu 104. In the exemplary embodiment, the reading menu 104 is arranged to correspond to a restaurant menu and includes an Appetizer Section, Main Course Section and Dessert Section. The Appetizer and Dessert sections may be optional and may provide extra credit or bonus points. In the exemplary embodiment of FIG. 1, each section, (e.g., Appetizer Section, Main Course Section and Dessert Section) is shown without additional listings. However, a list of books, literary works, or genre may be indicated under each section, as will be described in more detail in relation to FIG. 8.

The front cover 102 also includes an image 105 for added entertainment and visual excitement. In the exemplary embodiment, the image 105 includes a tray with a plurality of stacked books. Nonetheless, other images may be used. For example, a scene of a restaurant with a plurality of tables, patrons and waiters or waitresses delivering trays of books to the patrons may be shown. The image 105 may be age or grade level appropriate.

The back cover includes a reading log 120. The reading log 120 is represented as a table with a plurality of rows and columns to create cells or blocks. Each row is labeled a day of the week such as, MON, TUE, WED, THUR, and FRI. Each column is labeled a literary genre, such as Genre 1, Genre 2, Genre 3, Genre 4 and Genre 5. The cell or block associated with the row MON and column Genre 1 provides an area (cell or block) 122 to place an indicator by the user, teacher, tutor, or reader that the reading assignment corresponding to area 122 was completed. The reading assignment may be assigned by a teacher, tutor, parent or others.

Currently, school systems both public and private require readers to read every day or weekday. Oftentimes, the school provides a sheet of paper as a log to indicate what the reader has read with no guidance as to how and where to get age or reading level appropriate books. Thus, parents are oftentimes at a loss, cannot find appropriate books and do not fill out the log properly. The parents are burdened to provide the reader with various books so that the assignments can be performed. Many parents do not know what books is appropriate for their reader's reading skill. Furthermore, parents do not have access to a variety of books for each literary genre. Thus, readers will generally read one particular literary genre type and avoid the other genres which significantly limit the reader's exposure to literature.

Many parents are aware of poetry. However, parents generally do not have easy access to poetry age appropriate and entertaining to their reader. As a result, parents will tend to avoid introducing such a genre.

The RMF system 100 also provides a recommended reading assignment regime. For example, the RMF system 100 recommends reading a plurality of pages from each literary genre per day (weekday). The plurality of pages may be two pages per genre per day. The number of pages may vary based on the age or grade level of the reader. The RMF system 100 may also include a recommended book list customized for the school, grade, age, etc. for each literary genre.

In the exemplary embodiment, the plurality of literary genre may include Poetry, Biography or Autobiography, Non-Fiction, Realistic Fiction or Juvenile Fiction/Picture Books, and Fantasy, Legends or Mythology. Thus, Genre 1 may be Poetry. Genre 2 may be Biography or Autobiography. Genre 3 may be Non-Fiction. Genre 4 may be Realistic Fiction or Juvenile Fiction/Picture Books. Genre 5 may be Fantasy, Legends or Mythology. As can be appreciated, the Genre 1, Genre 2, Genre 3, Genre 4 and Genre 5 may be any one of the plurality of literary genre. The literary genres may vary by country. Furthermore, the RMF system may be modified to support a plurality of sub-categories to teach different sub-categories of a single literary genre, as will be described in more detail. For example, each folder may support a different sub-category while the whole RMF system 100 is for only one literary genre. For example, the RMF system 100 may be customized for only poetry (a single literary genre) wherein each folder is designated for a poetry sub-category. Each folder would include a title for the sub-category. The Main Course Section would list the sub-categories of the poetry. The Appetizer and Dessert Sections may include supplemental information about poetry to enhance the learning experience and genre exposure. For example, the Appetizer Section or Dessert Section may include one or more student poems, an article about one or more famous poets, and/or an article about the mechanics of writing poetry.

In another exemplary embodiment, the RMF system may be customized for a particular author. The Main Course Section would include a list of books for a single author. The Appetizer Section or Dessert Section may include one or more articles about the author or books by the author.

In another exemplary embodiment, the RMF system may be customized for a particular (English or Literature) class syllabus such as for a college class, high school class or the like. The RMF system would include the reading assignments according to the syllabus. Main Course Section would include a list of books recommended as per the syllabus. The Appetizer Section or Dessert Section may include one or more supplemental articles, books, assignments or handouts associated with the class and/or syllabus.

In an exemplary embodiment of FIG. 1, at least one pocket folder would be provided for each literary genre. The pocket folder would hold a literary work for the genre indicated in the heading of the pocket folder. Thus, there may be at least 5 pocket folders, one for each genre.

The area 122 may allow for a check or other mark. The area 122 may allow for the user to write out the name of the literary work associated with the genre. Nonetheless, in lieu of entering the literary genre as the column title, the title of the literary work associated with the genre may be substituted.

The back cover 112 further includes a name field 114 to enter a reader's name and a date field 116. In the exemplary embodiment, the date field 116 provides for entry of a week for which the reading assignments of the RMF system 100 is to be completed. While the date field 116 and the reading log 120 are associated with a time increment of a week, the reading log 120 and data field 116 may be associated with any time increment such as day, week, month, three months, bi-annually, annually, etc.

FIG. 2A illustrates a perspective view of a literature holding pocket folder 208A in accordance with some exemplary embodiments of the present invention. The literature holding pocket folder 208A includes a back sheet 230A and a front sheet 232A constructed and arranged to be closed, sealed or secured on three sides 234A, 235A and 236A to form a pocket. The top 238A side of the front sheet 232A is not secured to the back sheet 230A and provides an opening into the pocket so that literary work 252A may be slipped in and out of the pocket.

In the exemplary embodiment, the front sheet 232A is made of a transparent material to allow literary work 252A to be seen through the front sheet 232A.

The back sheet 230A includes a heading 239A configured to identify a menu section and/or literary genre. In the exemplary embodiment, the heading 239A is associated with a Main Course Section and a Genre 2. The literary work 252A has a title denoted by “TITLE 2” and an author name denoted by “Author 2”. The title and author name may be viewed through the front sheet 232A. Some literary works may not provide the author name on the front cover of the literary work. In such a case, the author name may be viewed from a spine of the literary work.

In FIG. 2A, the front sheet 232A is shorter than the back sheet 230A.

FIG. 2B illustrates a perspective view of yet another literature holding pocket folder 208B in accordance with some exemplary embodiments of the present invention. The literature holding pocket folder 208B is essentially the same as the pocket folder 208A except that the front sheet 232B has a length that is essentially the same as the length of the back sheet 230B. The back sheet 230B and front sheet 232B are constructed and arranged to be closed, sealed or secured on three sides 234B, 235B and 236B to form a pocket. The top of the front sheet 232B is not secured to the back sheet 230B and provides an opening into the pocket so that literary work 252B may be slipped in the pocket.

The pocket folders 208A and 208B may be a double sided pocket folder. In the exemplary embodiment, the pocket folder 208A or 208B may have a second pocket (NOT SHOWN) on the opposite side of the back sheet 230A or 230B. The second pocket would be essentially identical. Each pocket may include expansion panels to accommodate the width of the literary work to be slipped in the pocket. As the user's age or grade level increases, the size of the literary work may increase.

The RMF system 100 (FIG. 1) would include a plurality of pocket folders for the Main Course Section.

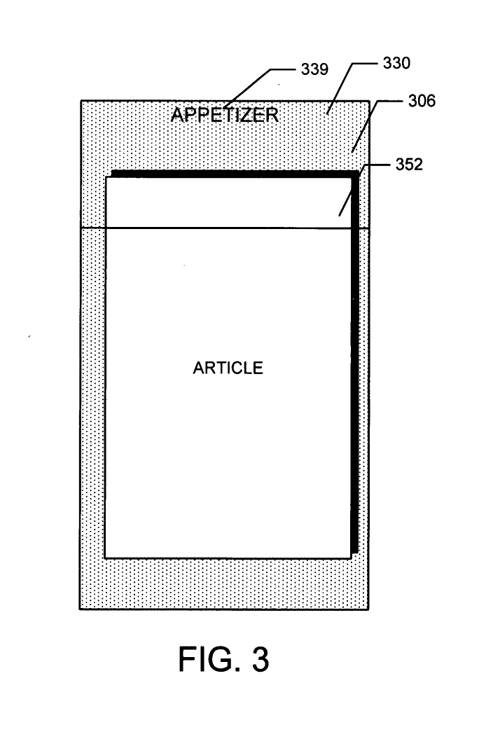

FIG. 3 illustrates a perspective view of a first (optional) literature holding pocket folder 306 holding a first type of literary work in accordance with some exemplary embodiments of the present invention. The first literature holding pocket folder 306 is constructed essentially the same as the pocket folder 208A. However, pocket folder 306 has a heading 339, on the back sheet 330, which is associated with an Appetizer Section. The pocket folder 306 may be associated with an article denoted by “ARTICLE” in a magazine, newspaper or other literary work 352 in the form of a short article or article. The literary work 352 may include a letter from a friend, pen pal, family member, teacher, or others.

The pocket folder 306 may be a double sided pocket folder with another pocket on the back side of back sheet 330. The pocket on the back side may include a different heading than heading 339. For example, the back side heading may begin with the Main Course Section. Nonetheless, the back side heading may be the same as the Appetizer Section.

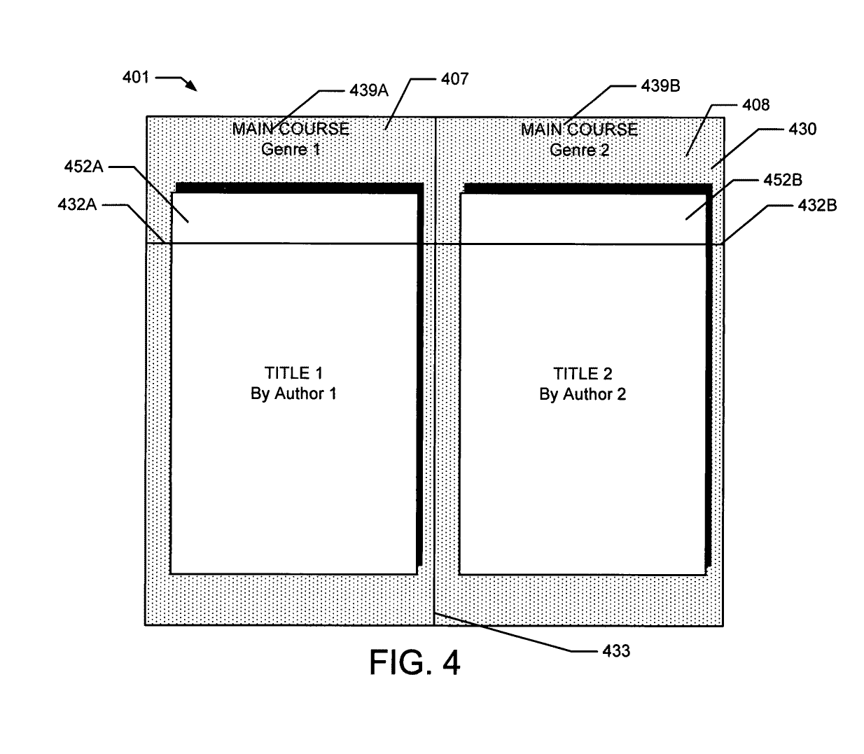

FIG. 4 illustrates a front view of a literature holding folder pair 401 holding two types of literary works in accordance with some exemplary embodiments of the present invention. The RMF system 100 (FIG. 1) may be made up of a plurality of pocket folders arranged in one or more folder pairs 401. The folder pair 401 includes a single back sheet 430 divided into first and second side-by-side pocket folders 407 and 408. The pocket folder 407 includes a first front sheet member 432A. The pocket folder 408 includes a second front sheet member 432B. The first front sheet member 432A and the second front sheet member 432B may be one sheet or two different sheets seamed together along seam 433. Seam 433 is a common closed, secured or sealed side of pocket folders 407 and 408.

The pocket folders 407 and 408 have headings 439A and 439B, respectively, on the back sheet 430, which are associated with a Main Course Section. The pocket folder 407 is associated with Genre 1 while pocket folder 408 is associated with Genre 2 of the Main Course Section. The literary work 452A has a title denoted by “TITLE 1” and an author name denoted by “Author 1”. The title and author name may be viewed through the front sheet 432A. The literary work 452A is associated with Genre 1 associated with the heading 439A. The literary work 452B has a title denoted by “TITLE 2” and an author name denoted by “Author 2”. The title and author name may be viewed through the front sheet 432B. The literary work 452B is associated with Genre 2 associated with the heading 439B.

In the RMF system 100, each page includes a pocket folder. Each page includes a front side and a back side. In the RMF system, each page may include two side-by-side pocket folders on only one side or on both sides (front side and back side). In a still further embodiment, the RMF system may include a plurality of side-by-side pocket folders per side of a page. The RMF system may include one pocket folder per side of a page.

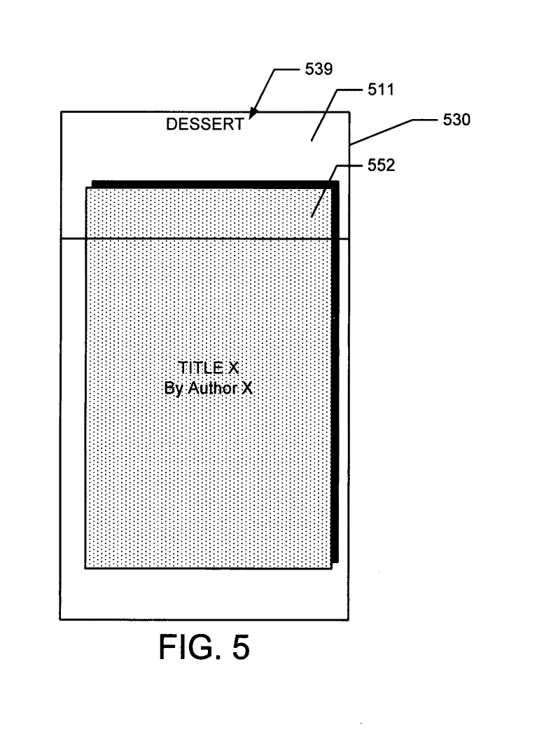

FIG. 5 illustrates a perspective view of a second (optional) literature holding pocket folder holding a type of literary works in accordance with some exemplary embodiments of the present invention. The second literature holding pocket folder 511 is constructed essentially the same as the pocket folder 208A. However, pocket folder 511 has a heading 539, on the back sheet 530, which is associated with a Dessert Section. The literary work 552 in the pocket folder 511 may be associated with a book of jokes, a book of riddles, comic book, a book of humorous anecdotes, Satire or the like to add entertainment and enjoyment for the reader. The literary work 552 in the Dessert Section may be optional and may be read for extra credit or bonus points.

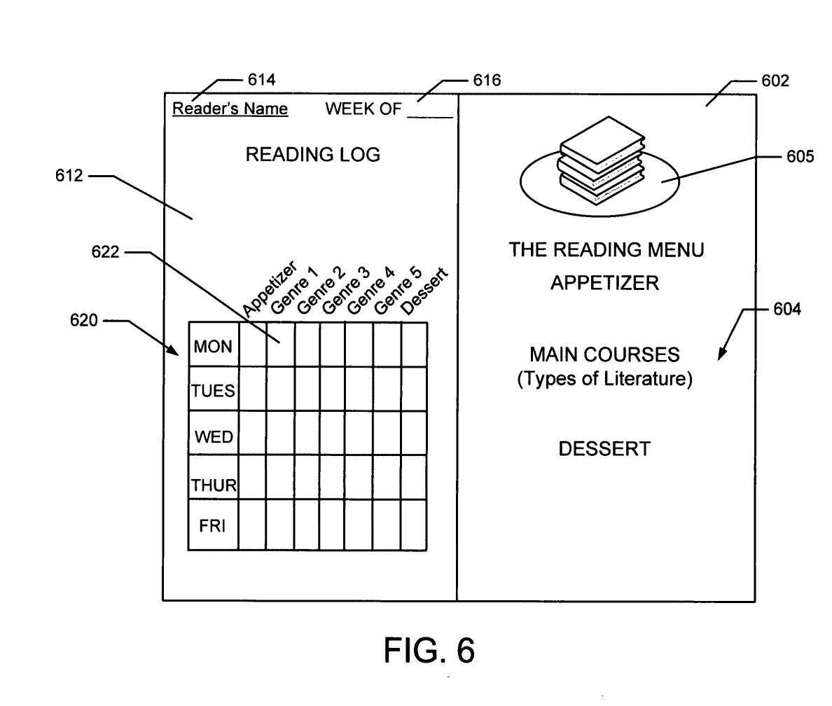

FIG. 6 illustrates a front view of front and back cover members 602 and 612 of yet another RMF system 600 in accordance with some exemplary embodiments of the present invention. The front cover 602 includes a reading menu 604. In the exemplary embodiment, the reading menu 604 is arranged to correspond to a restaurant menu and includes an Appetizer Section, Main Course Section and Dessert Section. The front cover 602 also includes an image 605 for added entertainment and visual excitement. In the exemplary embodiment, the image 605 includes a tray with a plurality of stacked books. Nonetheless, other images may be used and may be age appropriate.

The back cover 612 includes a reading log 620. The reading log 620 is represented as a table with a plurality of rows and columns. Each row is labeled a day of the week such as, MON, TUE, WED, THUR, and FRI. Each column is labeled according to all sections in the reading menu 604. The columns include entry for Appetizer and Dessert. Additionally, as previously described in relation to FIG. 1, the reading log 620 includes columns for each literary genre, such as Genre 1, Genre 2, Genre 3, Genre 4 and Genre 5. The cell or block associated with the row MON and column Genre 1 provides an area 622 to place an indicator by the user, teacher, tutor, or reader that the reading assignment corresponding to area 622 was completed. The reading assignment may be assigned by a teacher, tutor, parent or others.

The back cover 612 further includes a name field 614 for the reader's name and a date field 616 to enter a week, month or other time period from which the reading assignments are assigned or to begin.

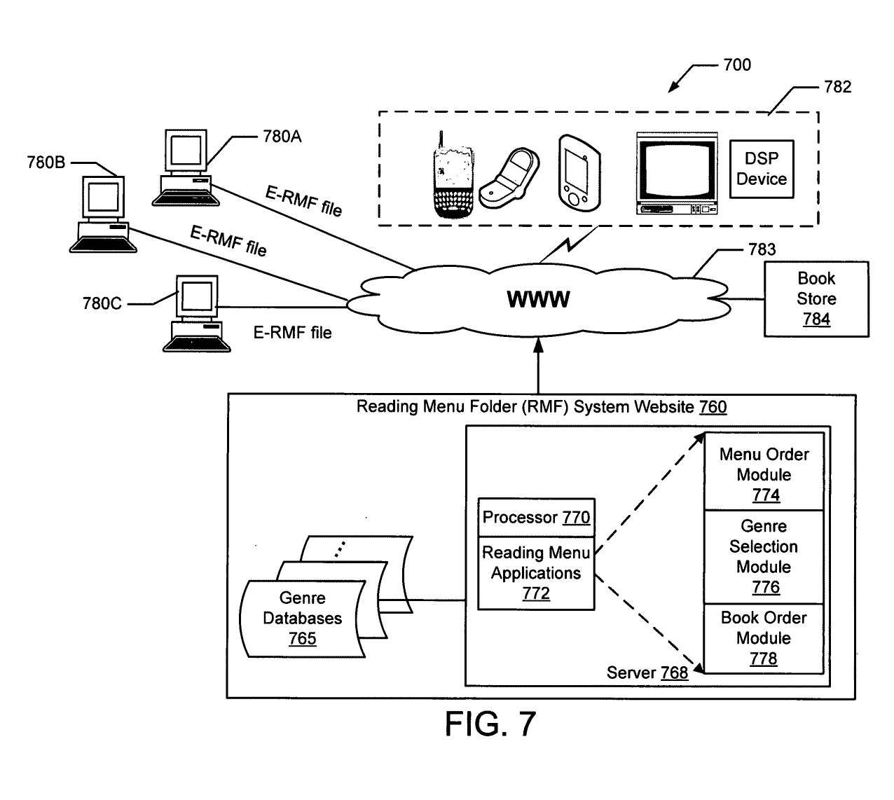

FIG. 7 illustrates an electronic RMF system 700 in accordance with some exemplary embodiments of the present invention. The electronic RMF system 700 includes a RMF system website 760 having at least one server 768 and a plurality of genre databases 765. The electronic RMF system 700 allows a user to customize the folder assembly during an online session. Alternately, the user many customize the folder assembly through mail order, telephone order, etc.

The website 760 would operate in accordance with a website platform having at least one server 768, security protocols and databases. The at least one server 768 includes at least one processor 770 and one or more reading menu applications 772. The reading menu applications 772 includes, without limitation, applications and programs to perform and customize menu ordering via a menu order module 774, genre selection via a genre selection module 776 and book ordering via a book order module 778. The books may be paperback, hard cover or e-books. Ordering books are optional and may be purchased at a local book store, online independent of the website 760 or other book purchasing mechanisms.

One or more users, teachers, tutors or others may access the RMF system website 760 using a personal computer (PC) 780A, 780B or 780C, Laptop, Notebook, etc. through the World Wide Web (WWW) or distributed content network 783 during an online session. Additionally, the one or more users, teachers, tutors, or others may access RMF system website 760 using a web-enabled user device 782 such an IPhones, cellular phone, Blackberry phone, digital signal processor (DSP) device, etc.

The web-enabled user device 782 may be any media or multi-media presentation device, such as a cellular phone, satellite phone, IPhones, a Voice over Internet Protocol (VoIP) phone, an interactive pager, a personal digital assistant (PDA), a television, and any communications device having a digital signal processor (DSP). The web-enabled user device 782 may also include any computer, peripheral device, camera, modem, storage device, telephone, mobile phone, analog/digital recorder, CD/DVD player/recorder, audio equipment, receiver, tuner, and/or any other consumer multi-communications device. The WWW or distributed content network 783 may include in whole or part a television/cable network operating in the radio-frequency domain and/or the Internet Protocol (IP) domain, a communications network, such as the Internet, an intranet, a satellite network, a telecommunications network (e.g., Public Switched Telephone Network, Mobile Switching Telephone Office, and others), a local-area network (LAN), virtual private network (VPN), and/or a wide-area network (WAN). The WWW or distributed content network 783 may include coaxial cables, copper wires, fiber optic lines, and/or hybrid-coaxial lines. The WWW or distributed content network 783 may even include wireless portions utilizing any portion of the electromagnetic spectrum and any signaling standard (such as the I.E.E.E. 802 family of standards). The communications address of the head end (or alternate delivery source of the program) may be an electronic data communications address, such as an email address, webpage, and/or an Internet Protocol (IP) associated address, and/or may be a telecommunications address, such as a telephone number or a communications address utilizing any frequency in the electromagnetic spectrum (e.g., short wave radio receiver).

The RMF system website 760 is configured to be accessed using an Internet Browser, or other applications to communication through a distributed content network 783 as known in the art. The RMF system website 760 would provide a plurality of graphical user interfaces (GUIs) to enable the user, teacher, tutor or others to customize each pocket folder for the age, grade level and/or interest of the reader by genre or menu sections (e.g., Appetizer Section, Main Course Section and Dessert Section).

The genre databases 765 would include recommended reading lists of recommended books by genre and age or grade level to be read. Each genre may include one or more genre sub-categories. For example, Genre 2 is associated with both Biographies and Autobiographies. Thus, the user would be permitted to select from the sub-category.

Genre 1 may have only one category identified as Poetry. However, the Poetry may be further sub-categorized into types of Poetry. There are numerous types of Poetry; some include epic, blank verse, ballad, etc. Genre 4 may be sub-categorized into Realistic Fiction or Juvenile Fiction/Picture Books. Genre 5 may be sub-categorized into Fantasy, Legends or Mythology.

Each sub-category may be further sub-categorized. For example, Mythology may be further sub-categorized into different types of mythology (e.g., Roman, Greek, Egyptian, etc.). The users would be able to customize the books based on their interest. As can be appreciated, sub-categories of each genre is extensive and prohibitive to provide each sub-category here. Thus, the examples are for illustrative purposes only.

In an embodiment, a book from the recommended reading list may be purchased directly or indirectly from the RMF system website 760. The RMF system website 760 may allow the user to purchase one or more books from a book store 784 through the WWW or distributed content network 783.

The website 760 may deliver or download an e-RMF system file to the user's computer 780A, 780B or 780C. In an alternate embodiment, the website 760 may be arranged to mail a hardcopy reading menu folder system (e.g., RMF system 100) to the user. The e-RMF system file would include a reading log so that the user can log completed reading assignments, manually or electronically. The user may be able to print from the computer a reading log that may be completed and taken to the teacher, tutor or others. Nonetheless, an electronic reading log may be sent electronically such as through email to a teacher, tutor or others. The website 760 may also receive the reading logs electronically to provide incentives to the user. The website 760 is configured to automatically track completion of reading assignments through the folders 767.

The website 760 may include reader reading menu folders 767 configured to electronically organize a reader's assignments and/or e-book files, articles, etc. The RMF system may be completely electronic. The RMF system 100 would be presented to the user or reader in an electronic version through a web browser. Hyper text links would, when selected by a user or reader, link to the electronic file associated with a book, article, reading assignments, reading lists, log entry fields, information, etc.

FIG. 8 illustrates a graphical user interface (GUI) 890 for use by the electronic RMF system 700 of FIG. 7 in accordance with some exemplary embodiments of the present invention. GUI 890 is shown in conjunction with an Internet Browser page 891. The GUI 890 includes a reading menu 894 with a plurality of menu sections, Appetizer 895A, Main Course 895B and Dessert 895C. The Appetizer Section 895A includes a plurality of hypertext links 896A denoted by an underline for a plurality of selections. The plurality of selections in the Appetizer Section 895A include a short article in a magazine, a short article in a newspaper, a short article in a professional journal, and other literary work.

The Main Course Section 895B includes a plurality of hypertext links 896B, denoted by an underline. Each hypertext link 896B is for a different Genre (e.g., Genre 1, Genre 2, Genre 3, Genre 4, and Genre 5). The Dessert Section 895C includes a plurality of hypertext links 896C, denoted by an underline. The plurality of selections in the Dessert Section 895C includes a comic book, book of jokes, book of riddles, and other. The Dessert Section may include a book of humorous anecdotes or Satire.

With reference to FIG. 1, the front cover 102 may include a printed version of the reading menu 894 illustrated in FIG. 8.

The reading menu 894 may be varied for a reader as compared to a teacher, parent, tutor, etc. The reading menu 894 in the reader reading menu folders 767 would have the selections already available to the reader. Selection of a hypertext link would display to the reader the e-file associated with the hyper text link or, alternately, an assignment description.

The reading menu 894 would be varied for teachers, tutors or the like to allow a user (teacher, tutor, parent, etc.) to setup and establish a reading menu folder and designate assignments for a reader. Depending on the age of the reader, the user and reader may perform both tasks.

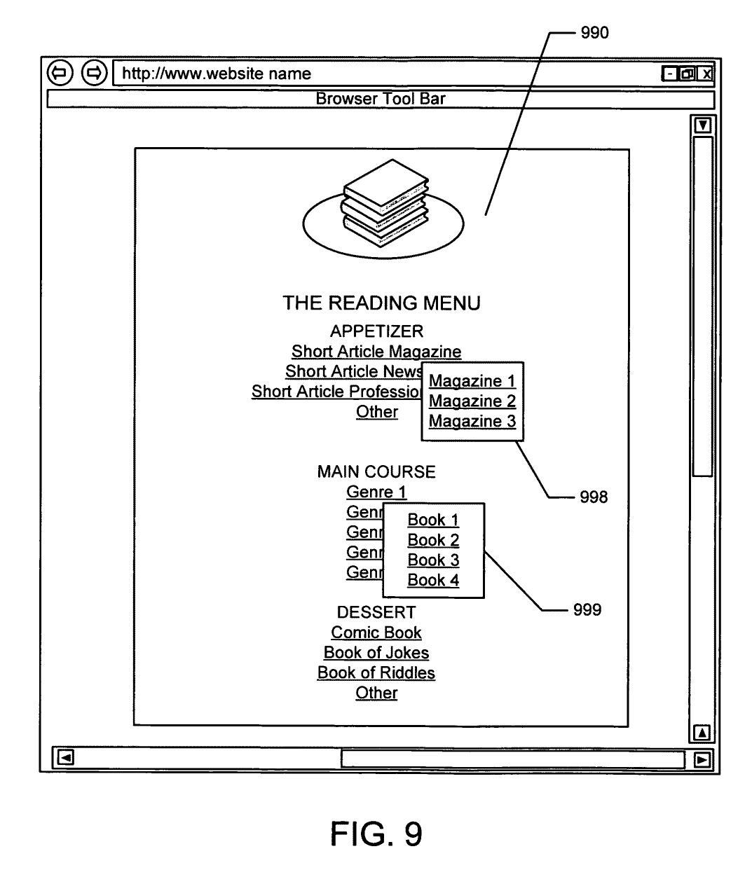

FIG. 9 illustrates a graphical user interface (GUI) 990 with drop down windows 998 and 999 in accordance with some exemplary embodiments of the present invention. The GUI 990 is essentially the same as GUI 890. When placing a cursor or other user interface on a hypertext link (FIG. 8), a drop down window 998 or 999 may be shown overlaid on the GUI 990. Alternately, if a hypertext link is selected (such as by a single or double click), the system 700 would navigate to a new GUI providing a list of sub-categories such as shown in windows 998 and 999. For example, when selecting or placing a cursor on the hypertext link associated with short article magazine, a window 998 or GUI would display a list of magazines or articles to allow a user to select a respective one entry of the list. In another example, when selecting or placing a cursor on the hypertext link associated with Genre 1, a window 999 or GUI would display a list of book titles to select a respective one entry in the list. The user may be given an option to purchase an electronic versions or hardcopy versions of a book, article, etc.

The list may include sub-categories as described previously. For example, when selecting or placing a cursor on the hypertext link associated with Genre 1, a window or GUI may list Poetry sub-categories so that the user, teacher, tutor or other can select the type of Poetry to customize the reading assignments based on interest, age, grade level, in coordination with a classroom curriculum, etc.

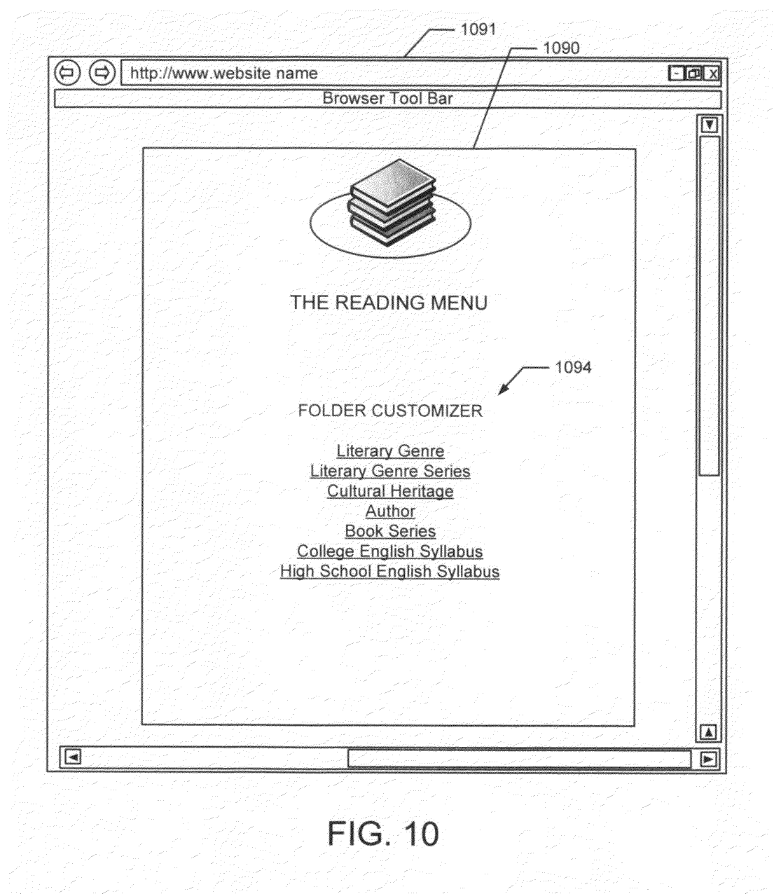

FIG. 10 illustrates a graphical user interface (GUI) 1090 for customizing a reading menu folder in accordance with some exemplary embodiments of the present invention. An Internet Browser page 1091 is shown to display the GUI 1090 for customizing a reading menu folder and assignments. The GUI 1090 includes a folder customizer list 1094 with a plurality of hypertext links or selections. The plurality of hypertext links or selections include, without limitation, literary genre, literary genre series, cultural heritage, author, book series, college English syllabus, and high school English syllabus. When selecting literary genre, only one literary genre is selected. The Main Course Section would be modified for a plurality of genre sub-categories. The literary genre series would set up the Main Course Section for a plurality of literary genre such as described in relation to FIG. 1. Selecting the cultural heritage by a user would organize the folder for a particular cultural heritage. Selecting a book series by a user, allows a user to select a series of books such as Dr. Seuss Books, Magic School Bus Series, Great Classics or other book collections. Selecting by a user a book written by author allows a user to select one or more books from a single author. The college or high school English syllabus allows a school or teacher to customize a folder for a particular class curriculum.

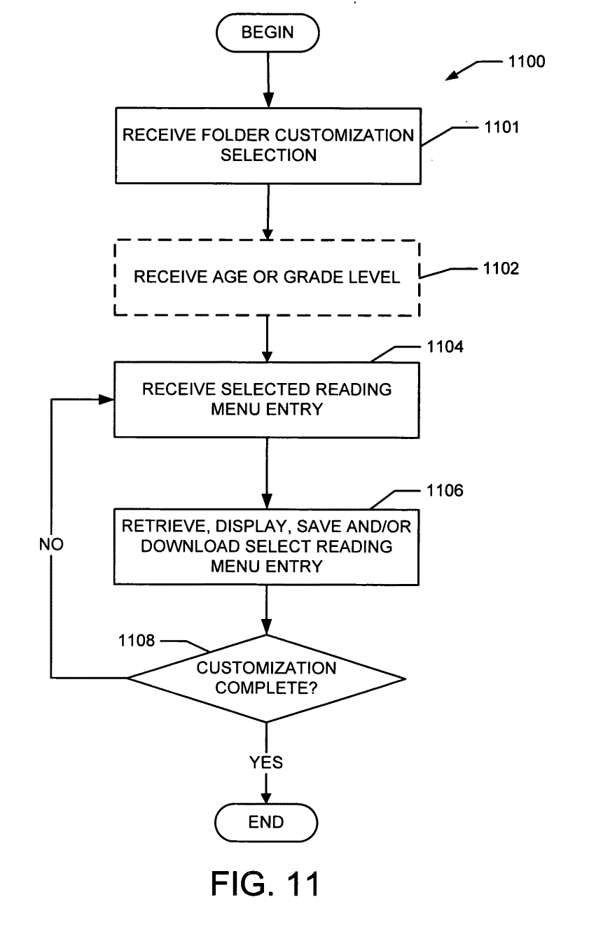

FIG. 11 illustrates a flow chart of a process 1100 to customize a reading menu folder to teach literature and/or literacy in accordance with some exemplary embodiments of the present invention. The process 1100 begins with step 1101 where the system receives a user's selection to customize a RMF system. The user may select to customize the RMF system for a selected cultural heritage, a selected author, a selected book series, a selected literary genre or genre with sub-categories. The user may customize the RMF system for a plurality of literary genres. The user may also customize the RMF system according to a class syllabus for college, high school or other grade levels.

At step 1102 a user (denoted as optional) may enter a selection for an age and/or grade level which is received by during the online session or other customization or ordering process. At step 1104, the system receives a selection of a Reading Menu Entry entered by the user. Returning again to FIG. 9, the user may select Book 3 in window 999 associated with literary genre 1 in the Main Course Section. The Book 3 in window 9999 is underlined to represent an hypertext link to retrieve the information associated with Book 3 in window 999. Alternately, the user may select a magazine shown in the window 998 associated with a short article magazine in the Appetizer Section.

Returning again to FIG. 11, at step 1106 the system will retrieve, display, save and/or download the selected Reading Menu Entry from the databases. At step 1108, the system will determine if the customization process is complete. If the determination is “NO,” the system loops back to step 1104. If the determination is “YES,” a process ends.

As can be appreciated, one or more of the steps may be omitted, performed in the depicted order or a different order than shown. One or more of the steps may be performed contemporaneously. Additional steps may also be added.

Additionally, the website may be modified to also track and log the reading assignments being completed. For example, if the books are e-books, the reading menu folder system may be set up at the website for access by the reader through the WWW during an online session. The website would present the customized electronic RMF system to the reader for use online. The RMF system of FIG. 1 may be modified to be electronic and saved online for a reader to access.

In operation, the RMF system allows a user to read a predetermined number of pages in each book. In an exemplary embodiment, a user would read at least two pages per genre so that the user is exposed to a plurality of literary genres. As the age of the reader increase more pages may be assigned.

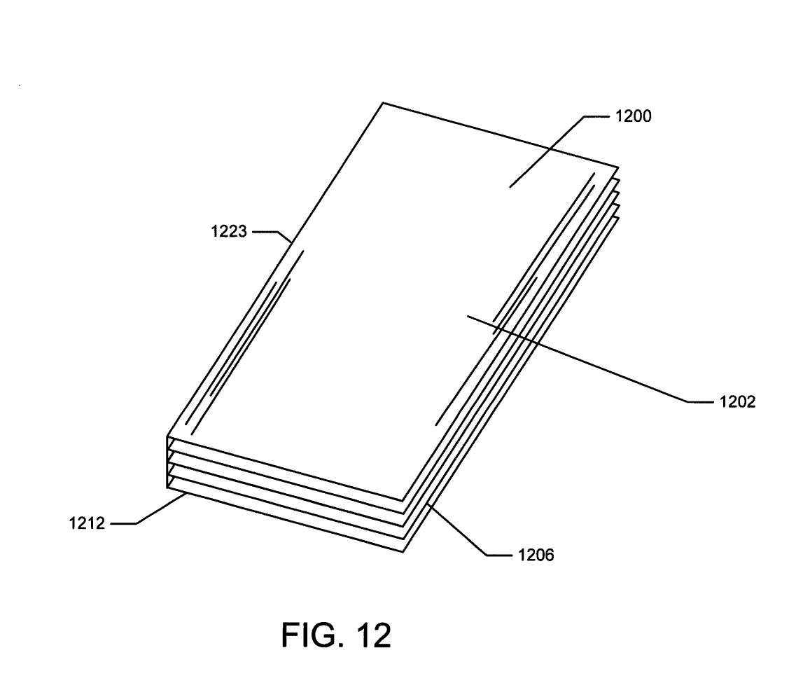

FIG. 12 illustrates yet another perspective view of reading menu folder (RMF) system 1200 in accordance with some exemplary embodiments of the present invention. The RMF system 1200 includes a front cover 1202, a back cover 1212, spine 1223 and a plurality of pocket folders 1206 between the front cover 1204 and the back cover 1212. The RMF system 1200 is essentially the same as the system of FIG. 1 except that the spine 1223 allows the RMF system 1200 to hold and organize larger sized hardcopy books.

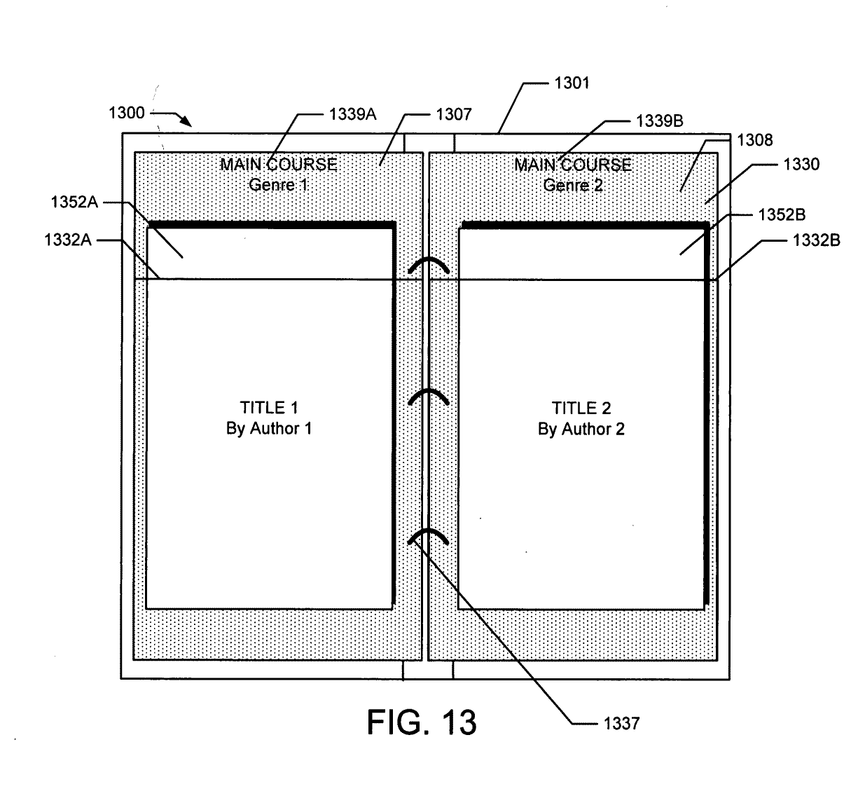

FIG. 13 illustrates yet another RMF system 1300. The RMF system 1300 includes a folder assembly cover 1301 with binder rings 1337 that allow multiple pocket folders (only 1307 and 1308) shown side by side. The binder rings can open and close with a spring bias to allow pocket folders to be added. Each pocket folder includes a single back sheet 1330. The pocket folder 407 includes a first front sheet member 1332A. The pocket folder 408 includes a second front sheet member 1332B. The first front sheet member 1332A and the second front sheet member 1332B are seamed to the corresponding back sheet 1330. The pocket should be dimensions to fit books therein.

The pocket folders 1307 and 1308 have headings 1339A and 1339B, respectively, on the corresponding back sheet 1330, which are associated with a Main Course Section. The pocket folder 1307 is associated with Genre 1 while pocket folder 1308 is associated with Genre 2 of the Main Course Section. The literary work 1352A has a title denoted by “TITLE 1” and an author name denoted by “Author 1”. The title and author name may be viewed through the front sheet 1332A. The literary work 1352A is associated with Genre 1 associated with the heading 1339A. The literary work 1352B has a title denoted by “TITLE 2” and an author name denoted by “Author 2”. The title and author name may be viewed through the front sheet 1332B. The literary work 1352B is associated with Genre 2 associated with the heading 1339B.

In view of the foregoing, the RMF systems described above are arranged in the form of a restaurant menu with sections for Appetizer, Main Course and Dessert.

In view of the foregoing, the system of the present invention can be used to help children who need to develop or improve reading skills. The system can also be used to improve adult literacy.

The RMF systems described herein may be used to as a teaching tool and may be customized to correspond to a class reading curriculum.

The system can be customized to hold books in Braille for visually impaired.

In operation the reader is exposed to a plurality of types of literature daily. The user or reader is assigned a relatively small number of pages which may vary based on age. The assignments increase the reader's exposure to literature in small increments for interest and entertainment.

The system monitors the reader's daily reading. While not wishing to be bound by theory, as a result of the daily reading, of a plurality different literary genre, different authors, the reader's vocabulary increases and the reader learns to think more creatively. The reader also learns to think from different perspectives.

Each author and book exposes the reader to thoughts and perspectives of others (authors). In addition, the assignment for each genre is short (e.g., two pages per book). Readers will find greater interest in one particular book or genre than another and will want to keep reading the book. Readers will get involved and discover that they want to read more and anticipate the next day's reading assignments.

While not wishing to be bound by theory, the two page rule “tricks” the reader into wanting to read more.

In operation, as the reader completes the entire book, the reader inserts another book of the same literary genre into the folder associated with the literary genre of the book.

In view of the above, the RFM system is configured to provide children a daily opportunity to be exposed to a wide array of literature and effectuates vocabulary development and creative thinking.

In one or more exemplary configurations, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer and to store databases. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. A reading menu folder system comprising:
a front cover;
a back cover having a reading assignment log; and
a plurality of folders, each folder being associated with a literary genre or literary genre sub-category and configured to hold a book associated with the literary genre or the literary genre sub-category.

2. The system according to claim 1, wherein the folder includes at least one pocket configured to receive and hold therein the book.

3. The system according to claim 2, wherein the pocket includes a transparent sheet.

4. The system according to claim 1, further comprising a plurality of books, each book associated with a different literary genre.

5. The system according to claim 1, wherein at least one first folder is associated with Poetry; at least one second folder is associated with Biography or Autobiography; at least one third folder is associated with Non-Fiction; at least one fourth folder is associated with Realistic Fiction or Juvenile Fiction/Picture Books; and at least one fifth folder is associated with Fantasy, Legends or Mythology.

6. The system according to claim 1, further comprising a first folder associated with an appetizer menu section and a second folder associated with a dessert menu section wherein the plurality of folders are associated with a main course menu section and the front cover includes a menu list of menu sections.

7. The system according to claim 1, wherein the front cover and back cover are constructed and arranged as a binder with a spine.

8. An electronic reading menu folder system comprising:
memory for storing instructions; and
processor for executing a set of the stored instructions to customize a reading menu folder system with literary works and reading assignments.

9. The system according to claim 8, wherein the reading menu folder system includes a folder assembly with at least one pocket configured to receive and hold therein the literary work.

10. The system according to claim 9, wherein the pocket includes a transparent sheet.

11. The system according to claim 9, further comprising a plurality of pockets and a plurality of books, each book associated with a different literary genre.

12. The system according to claim 11, wherein at least one first folder is associated with Poetry; at least one second folder is associated with Biography or Autobiography; at least one third folder is associated with Non-Fiction; at least one fourth folder is associated with Realistic Fiction or Juvenile Fiction/Picture Books; and at least one fifth folder is associated with Fantasy, Legends or Mythology.

13. The system according to claim 11, further comprising a first folder associated with an appetizer menu section and a second folder associated with a dessert menu section wherein the plurality of folders are associated with a main course menu section and the front cover includes a menu list of menu sections.

14. The system according to claim 8, wherein the reading menu folder system comprises an electronic folder associated with a reader wherein the folder is accessible by the reader during an online session and wherein at least one first folder is associated with Poetry; at least one second folder is associated with Biography or Autobiography; at least one third folder is associated with Non-Fiction; at least one fourth folder is associated with Realistic Fiction or Juvenile Fiction/Picture Books; and at least one fifth folder is associated with Fantasy, Legends or Mythology.

15. The system according to claim 14, wherein the reading menu folder system automatically tracks completion of assignments of the reader.

16. The system according to claim 8, wherein the processor is configured to directly or indirectly order books or literary works associated with the reading assignments.

17. The system according to claim 8, wherein the literary works includes one of books of poetry, great classic books, books of a book series, books of a designated author, books of a school curriculum or books of a plurality of literary genre.
